(19) United States
(12) Patent Application Publication
(10) Pub. No.: US 2017/0314618 A1
(43) Pub. Date: Nov. 2, 2017

(54) BEARING ASSEMBLY WITH HYBRID COATING

(71) Applicant: Innovative Mechanical Solutions, LLC, Houston, TX (US)

(72) Inventor: Michael Allen Speckert, Houston, TX (US)

(21) Appl. No.: 15/139,822

(22) Filed: Apr. 27, 2016

(51) Int. Cl. F16C 33/12; F16C 33/04; F16C 17/02

(52) U.S. Cl. CPC F16C 33/124; F16C 33/043; F16C 17/02; F16C 2206/56

(57) ABSTRACT

Among other things, a bearing assembly comprising a hybrid coating is provided. A bearing assembly may comprise a substrate having a surface and a hybrid wear resistant coating over the surface of the substrate. In an example, the substrate may be an inner radial bearing and/or and outer radial bearing within a bearing assembly. The hybrid wear resistant coating may comprise a high wear resistant coating and a low wear resistant coating. The high wear resistant coating may comprise a wear resistant matrix over the surface and a set of wear resistant elements within the wear resistant matrix. In an example, wear elements within the set of wear elements may comprise tungsten carbide. The low wear resistant coating may be over a low wear area of the surface. In an example, the low wear resistant coating may be positioned between the first high wear resistant coating and a second high wear resistant coating.

### BACKGROUND

Bearing assemblies may be utilized in many mechanical components, such as motors, wheels, medical devices, etc. For example, mud motors, such as those used for drilling in the exploration of oil, may utilize bearing assemblies. The bearing assemblies in mud motors may include two sets of radial bearings, an upper radial bearing set and a lower radial bearing set. The upper radial bearing set and the lower radial bearing set may each comprise an inner rotating bearing and an outer rotating bearing. During normal drilling operations, such as directional drilling processes, bending loads applied to a bearing assembly may create high side-loading forces (e.g., wear forces) causing the inner rotating bearing and the outer rotating bearing to come into contact with each other. As a result, the inner rotating bearing and the outer rotating bearing are subjected to high degrees of abrasion and galling wear, such as where an outer surface of the inner rotating bearing contacts an inner surface of the outer rotating bearing. Additionally, bearing assemblies may be subjected to wear from high mechanical stresses, such as from cyclical loading and impacts. Over time, wear on the bearing assemblies may cause loss of functionality/performance, and eventual failure.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more bearing assemblies and/or techniques for forming bearing assemblies are provided herein. The bearing assemblies may comprise a substrate having a surface, such as an outer surface and/or an inner surface of a radial bearing. A hybrid wear resistant coating may be provided over the surface of the substrate. The hybrid wear resistant coating may comprise a high wear resistant coating over a high wear area of the surface and a low wear resistant coating over a low wear area of the surface. The high wear resistant coating may comprise a wear resistant matrix and a set of wear resistant elements within the wear resistant matrix. The wear resistant elements within the set of wear resistant elements may comprise rods, bars, tiles, sphere, and/or agglomerate of a wear resistant compound. In an example, the wear resistant elements may comprise tungsten carbide and/or other metal carbide, a metal boride, and/or a diamond crystalline compound. A rate of wear in the high wear area is greater than a rate of wear in the low wear area (e.g., in the absence of the high wear resistant coating and the low wear resistant coating). For example, the high wear area may (e.g., more frequently) come into contact with other materials, surfaces, substrates, etc. as compared to the low wear area, and thus the high wear area may be subject to more friction than the low wear area. Accordingly, the high wear area may wear away more quickly than the low wear area.

In an example, a second high wear resistant coating may be over a second high wear surface of the substrate. The first high wear resistant coating and the second high wear resistant coating may be positioned proximate opposing ends of the substrate so as to evenly distribute wear forces that may be applied to the substrate. The low wear resistant coating may be positioned over the substrate and between the first high wear resistant coating and the second high wear resistant coating. In an example, the hybrid wear resistant coating may have a uniform thickness (e.g., the hybrid wear resistant coating may form a level coating surface on the top of the surface of the substrate).

In an example, the bearing assembly may comprise an outer radial bearing having a first end, a second end, and an interior surface that defines an interior cavity. A first hybrid wear resistant coating may be over the interior surface of the outer radial bearing. The hybrid wear resistant coating may comprise a first high wear resistant coating over the interior surface proximate the first end, a second high wear resistant coating over the interior surface proximate the second end, and a first low wear resistant coating over the interior surface between the first high wear resistant coating and the second high wear resistant coating. In an example, the bearing assembly may comprise an inner radial bearing positioned within the interior cavity having a third end, a fourth end, and an exterior surface parallel to the interior surface of the outer radial bearing. A second hybrid wear resistant coating may be over the exterior surface of the inner radial bearing. The second hybrid wear resistant coating may comprise a third high wear resistant coating over the exterior surface proximate the third end, a fourth high wear resistant coating over the exterior surface proximate the fourth end, and a second low wear resistant coating over the exterior surface between the third high wear resistant coating and the fourth high wear resistant coating. In an example, the first high wear resistant coating may be positioned parallel to the third high wear resistant coating and the second high wear resistant coating may be positioned parallel to the fourth high wear resistant coating. In an example, the inner radial bearing and the outer radial bearing are rotational relative to one another (e.g., the inner radial bearing may be rotational and the outer radial bearing may be stationary or vice versa).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of a top down view of a bearing assembly in accordance with some embodiments.

FIG. 2A is an illustration of a top down view of a bearing assembly in accordance with some embodiments, wherein a hybrid coating includes a first high wear resistant coating and a second high wear resistant coating.

FIG. 2B is an illustration of a top down view of a bearing assembly in accordance with some embodiments, wherein a hybrid coating includes a first high wear resistant coating and a second high wear resistant coating.

FIG. 2C is an illustration of a top down view of a bearing assembly in accordance with some embodiments, wherein a hybrid coating includes a first low wear resistant coating, a second low wear resistant coating, and a third low wear resistant coating.

FIG. 2D is an illustration of a top down view of a bearing assembly in accordance with some embodiments, wherein a hybrid coating includes a first high wear resistant coating, a second high wear resistant coating, and a third high wear resistant coating.

FIG. 2E is an illustration of a top down view of a bearing assembly in accordance with some embodiments, wherein a first high wear resistant coating and a second high wear resistant coating comprise wear resistant elements of various shapes and/or configurations.

FIG. 3A is an illustration of a cross sectional view of a bearing assembly in accordance with some embodiments.

FIG. 3B is an illustration of a cross sectional view of a bearing assembly in accordance with some embodiments.

FIG. 3C is an illustration of a cross sectional view of a bearing assembly in accordance with some embodiments.

FIG. 3D is an illustration of a cross sectional view of a bearing assembly in accordance with some embodiments.

FIG. 4A is an offset perspective cut away view of a bearing assembly according to some embodiments, wherein the bearing assembly comprises an inner radial bearing and an outer radial bearing.

FIG. 4B is a perspective cut away view of a bearing assembly according to some embodiments, wherein the bearing assembly comprises an inner radial bearing and an outer radial bearing.

FIG. 4C is a cross sectional view of a bearing assembly according to some embodiments, wherein the bearing assembly comprises an inner radial bearing and an outer radial bearing.

FIG. 5 illustrates a flow diagram of an exemplary method for forming a hybrid coating on a bearing assembly.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

As provided herein, a bearing assembly may comprise a substrate having a surface and a hybrid wear resistant coating over the surface of the substrate (e.g., the substrate may be an inner radial bearing and/or and outer radial bearing of the bearing assembly). The hybrid wear resistant coating may comprise a high wear resistant coating and a low wear resistant coating. The high wear resistant coating may comprise a wear resistant matrix over the surface of the substrate and a set of wear resistant elements within the wear resistant matrix. In an example, wear elements within the set of wear elements may comprise tungsten carbide. The low wear resistant coating may be over a low wear area of the surface.

A hybrid wear resistant coating may increase the performance and/or life span of the bearing assembly. For example, by utilizing wear resistant elements in high wear areas, the bearing assembly may wear more uniformly and thus operate as intended for a longer period of time (e.g., as compared to not utilizing wear resistant elements). Moreover, utilizing the wear resistant matrix more securely joins the wear resistant elements to the substrate (e.g., as compared to not utilizing the matrix) such that the wear resistant elements are less likely to become dislodged. The low wear resistant coating of the hybrid wear resistant coating may provide improved protection over low wear areas of bearing component surfaces. In this way, the hybrid wear resistant coating may reduce wear and/or make wear more uniform.

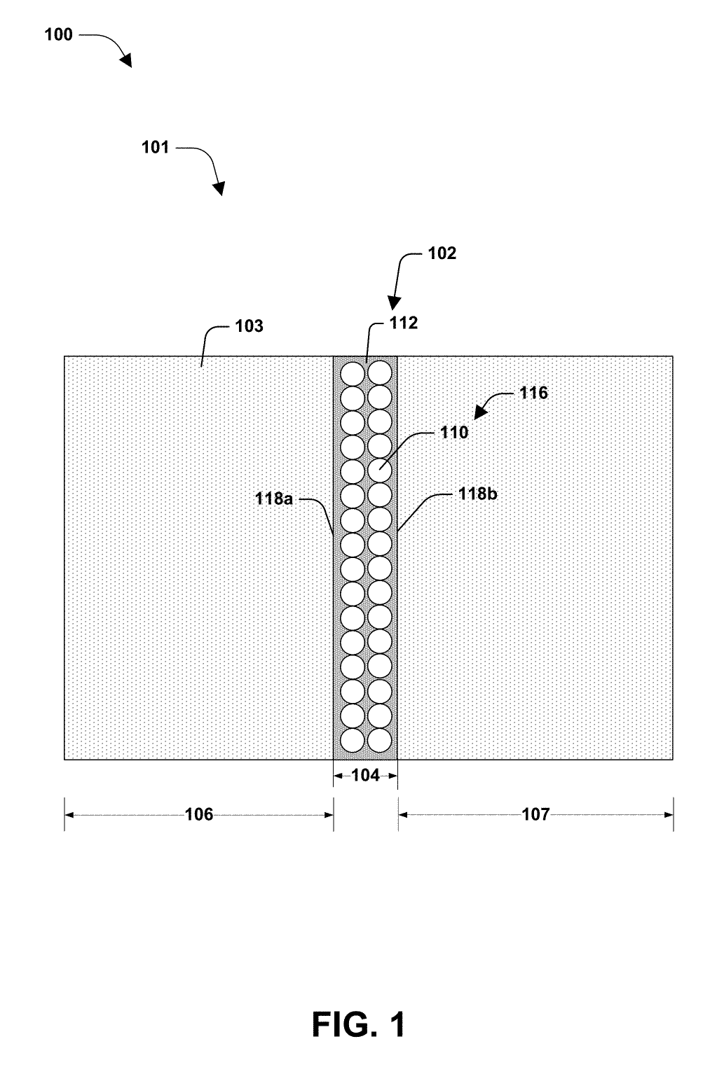

FIG. 1 illustrates a top down view of a bearing assembly 100 comprising a hybrid wear resistant coating 101. The hybrid wear resistant coating 101 may comprise a high wear resistant coating 102 and a low wear resistant coating 103. The hybrid wear resistant coating 101 may be provided over a surface of a substrate (not illustrated), such as a cylindrical surface of a component within the bearing assembly 100 (e.g., the substrate may comprise an outer surface of an inner bearing or an inner surface of an outer bearing). The high wear resistant coating 102 may be over a high wear area 104 of the surface of the substrate and the low wear resistant coating 103 may be over a low wear area of the surface of the substrate, such as a first low wear area 106 and/or a second low wear area 107. In an example, the low wear areas 106-107 may be located proximate the high wear area 104 (e.g., the low wear areas 106-107 of the surface may be located on opposing sides 118a and 118b of the high wear area 104). In an example, the high wear area 104 may correspond to a portion of the bearing assembly 100 that is subject to high side-loading forces, such as areas on an inner/outer radial bearing component that regularly contact an outer/inner radial bearing component (e.g., areas subjected to high degrees of abrasion, galling wear, etc.).

It will be appreciated that the high wear resistant coating 102 is illustrated as being located between the low wear areas 106-107. However, in an example, the high wear resistant coating 102 may be located at an end (e.g., adjacent an end of the first low wear area 106 and/or an end of the second low wear area 107). As such, the high wear resistant coating 102 can be located adjacent the first low wear area 106, such that the second low wear area 107 may not be provided. Alternatively, the high wear resistant coating 102 can be located adjacent the second low wear area 107, such that the first low wear area 106 may not be provided. The high wear resistant coating 102, therefore, need not be located between two low wear areas (e.g., the first low wear area 106 and the second low wear area 107), but, rather, at the end of one of the low wear areas.

In an example, the high wear resistant coating 102 may comprise a wear resistant matrix 112 and a set of wear resistant elements 116. The set of wear resistant elements 116 may be in the wear resistant matrix 112 (e.g., an LMI process may be utilized to form a metallurgical bond between the wear resistant matrix and the wear resistant elements). In an example, the wear resistant matrix 112 may comprise hard particles, alloying additives, and/or binders (e.g., metallic binders, organic binders, etc.). The hard particles may comprise tungsten carbide, polycrystalline diamond, silicon carbide, silicon nitride, polycrystalline tungsten carbide, spheroidized tungsten carbide, titanium nitride, titanium carbide, alumina, niobium, vanadium carbide, chromium carbide, and/or ceramics thereof (e.g., the hard particles may be from compounds having a Vickers number between about 2200 and 2900). In an example, the hard particles may be provided as a powder and/or a micro-particle. The alloying additive may comprise a compound added to impart a specialized characteristic on an alloy, such as increasing the alloys hardness and/or modifying the alloys melting point. In an example, the alloying additive may comprise an elemental metal in a powder form (e.g., manganese, titanium, chromium, etc.).

In an example, a wear resistant element 110 within the set of wear resistant elements 116 may be shaped as a button (e.g., a semi-spherical structure having a flat upper surface and/or a flat lower surface). In other embodiments, the wear resistant element 110 may be shaped as a rod, a bar, a tile (e.g., rectangular tile, circular tile, triangular tile, square tile, hexagonal tile, octagonal tile, etc.), a sphere, a block, a free flowing flat structure, and/or other three-dimensional shape (e.g., cube, ovoid, irregular shaped agglomerate, etc.). The set of wear resistant elements 116 may be arranged randomly and/or in a plurality of patterns and/or arrangements. For example, the wear resistant elements within the set of wear resistant elements 116 may be arranged into rows (e.g., evenly spaced rows, staggered rows, zigzagging rows, etc.), and/or sporadically disbursed within the wear resistant matrix 112. The arrangement of the set of wear resistant elements 116 may be determined based upon an intended application for the bearing assembly 100, an identified wear issue of the bearing assembly 100, and/or a size of the high wear area 104 (e.g., wear resistant elements may be placed in the high wear area 104 to maximize the number of wear resistant elements without negatively impacting the stability of the bearing assembly, unduly increasing manufacturing costs, etc.). In an example, the arrangement employed for the high wear area 104 and/or the shape of the wear resistant element utilized may improve the function, maintenance cycle, and/or life cycle for the bearing assembly 100 (e.g., smaller cylindrical bearing may utilize thinner wear resistant elements spaced closer together, etc.).

In an example, the wear resistant elements, such as wear resistant element 110, may comprise metal oxides, metal nitrides, metal borides, metal carbides, and/or alloys thereof. For example, the wear resistant elements may comprise tungsten carbide, sintered tungsten carbide, monocrystalline tungsten carbide, macrocrystalline tungsten carbide, multicrystal tungsten carbide, polycrystalline tungsten carbide, spherical cast tungsten carbide (e.g., a eutectic of WC-W2C), and/or the like. In an example, the wear resistant elements may comprise ceramics and/or nanocrystalline microstructures with mixtures of ceramics therein. In an example, the wear resistant elements may comprise compounds selected based upon, among other things, hardness and/or wettability. For example, at least some of the compounds of the wear resistant elements may possess a hardness greater than 8.5 Mohs, a Vickers number greater than 2300, a hardness value greater than 1400 HV, and/or a shear modulus greater than 274 GPa. In an example, utilizing wear resistant elements, such as solid tiles or buttons, in wear resistant coatings may offer excellent wear protection over other forms of wear protections, such as those utilizing hard particles alone.

In an example, the wear resistant matrix 112 may form a metallurgical bond with the substrate and the set of wear resistant elements 116 (e.g., the braze alloy may be utilized as part of a cloth-based liquid metal infiltration (LMI) process to form an infiltration layer comprising the metallurgical bond there between). The wear resistant elements may be positioned in the wear resistant matrix 112 in such a way as to substantially encapsulate the wear resistant elements. In this regard, the bond strength between the substrate and the wear resistant elements may be increased as a result of a greater surface area of the wear resistant elements contacting the wear resistant matrix 112 (e.g., 40% to 100% of the total surface area of the wear resistant elements may be contacted by the wear resistant matrix 112). Thus, the wear resistant matrix 112 may securely bond the set of wear resistant elements 116 to the substrate.

In an example, at least some of an LMI process includes heating a metal above its melting temperature to become a molten infiltrant. The molten (liquid) infiltrant may then be allowed to infiltrate into a (e.g., porous) substrate whose solidus point is greater than that of the molten infiltrant, such as by capillary force and/or external force (e.g., where chemical compatibility with the substrate is low), for example.

LMI may, for example, involve working a binder (e.g., polytetrafluoroethylene) with a (e.g., powdered) metal alloy to form a flexible cloth. In an example, a first cloth made with hard particle may be applied over a surface to be wear coated and may be fixed in place using a temporary adhesive. A second cloth made with a (e.g., powdered) braze alloy may be applied over the first cloth, and again fixed in place using a temporary adhesive. The braze alloy may be selected to have a melting temperature that is lower than that of the material to be wear coated. The surface to be wear coated, with cloths affixed, may be placed in a controlled, inert atmosphere such as vacuum or hydrogen and heated to a temperature above the liquidus point of the alloy. A binder (e.g., PTFE) of one or more of the cloths may at least partially evaporate, allowing infiltration of the alloy (e.g., in liquid form) into the material to be wear coated. The items may then be cooled below the solidification temperature of the infiltrant. In an example, one or more techniques for performing LMI are disclosed in U.S. Pat. No. 3,743,556 to Breton et al., the contents of which are hereby incorporated by reference herein.

In an example, the low wear resistant coating 103 may be over the low wear areas 106-107 and/or may be positioned proximate the high wear resistant coating 102. For example, the low wear resistant coating 103 may be in direct contact with the substrate below the low wear areas 106-107 and/or in direct contact with side boundaries 118a-118b of the high wear resistant coating 102. In an example, the low wear resistant coating 103 may comprise hard carbide particles disbursed in metallic binders (e.g., a tungsten carbide powder may be disbursed in a nickel alloy-containing matrix). The hard carbide particles and/or the metallic binder of the low wear resistant coating 103 may form a second metallurgical bond between a portion of the substrate corresponding to the low wear areas 106-107 and/or the high wear resistant coating 102 (e.g., the metallurgical bond may be formed through the utilization of a LMI process and/or a weld overlay process). In an example, the metallurgical bond may be formed at the interface between the low wear resistant coating 103 and at least one of the substrate and/or the high wear resistant coating 102 (e.g., boundaries 118a-118b). In yet another example, the low wear resistant coating 103 may comprise the same metal alloys and/or metallic binders as the high wear resistant coating 102 (e.g., the wear resistant matrix 112 may comprise tungsten carbide hard particles and the low wear resistant coating 103 may also contain tungsten carbide hard particles).

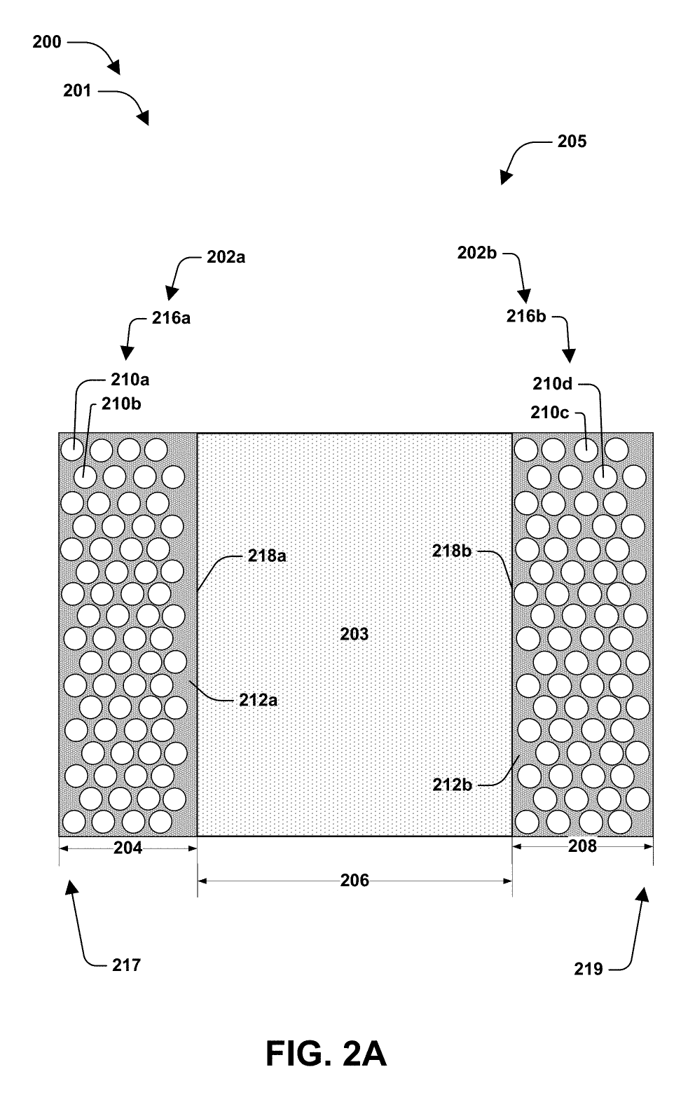

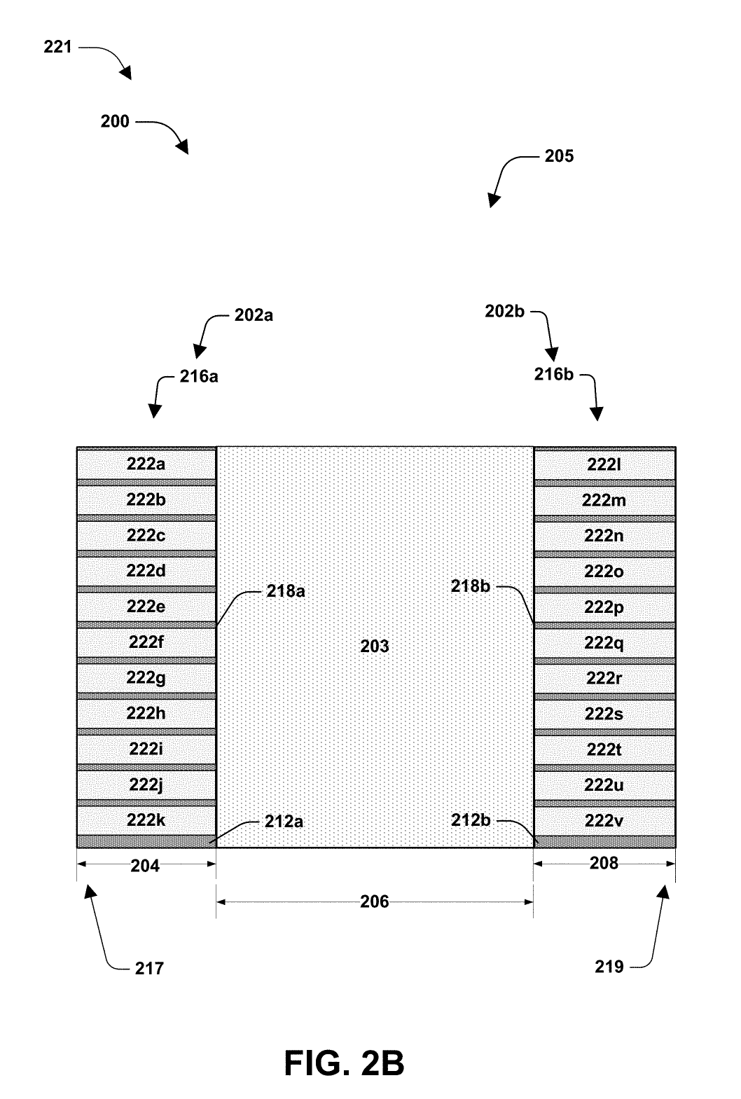

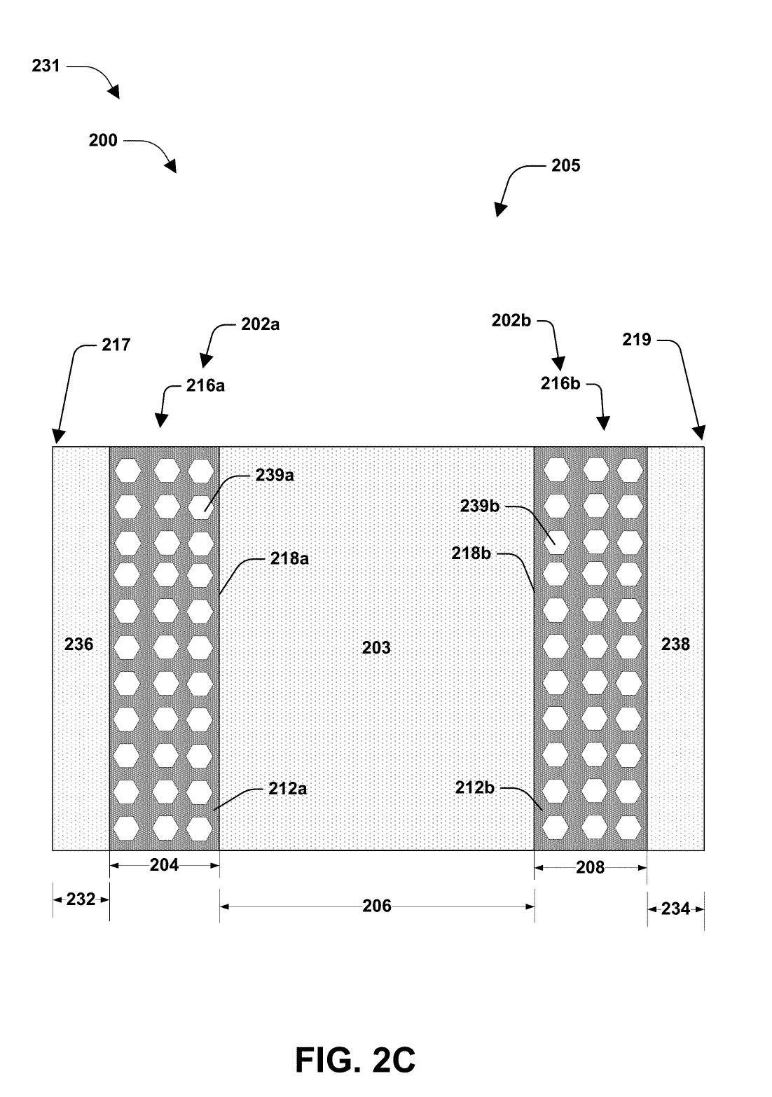

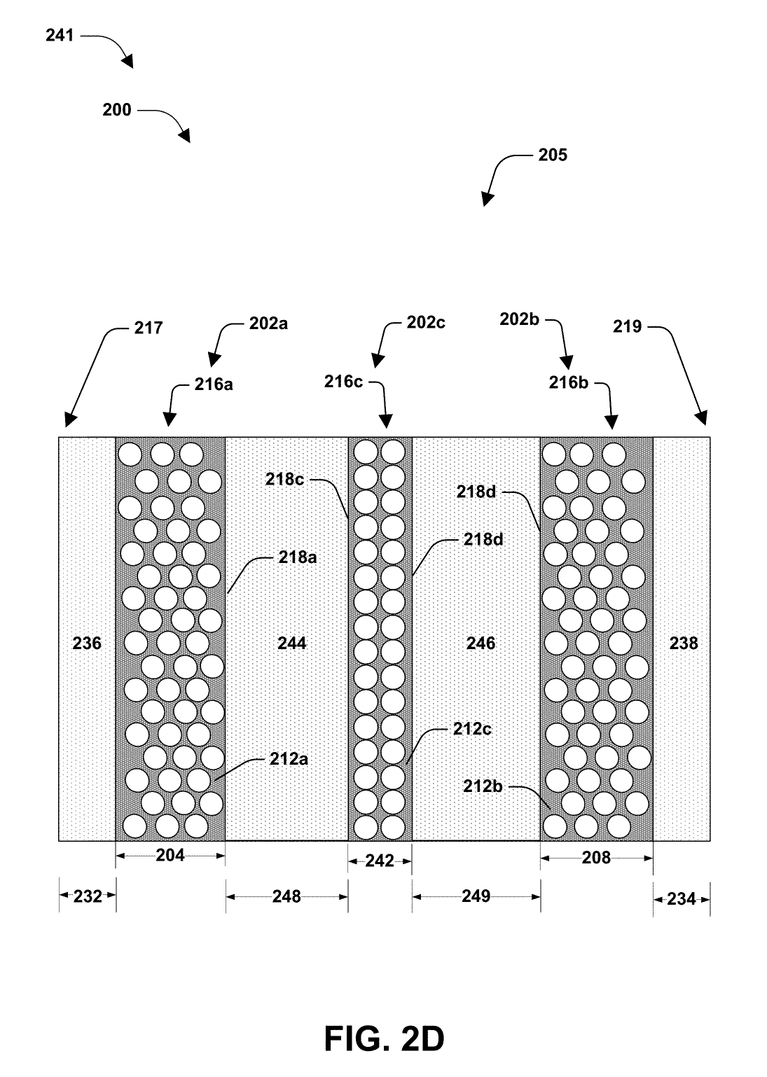

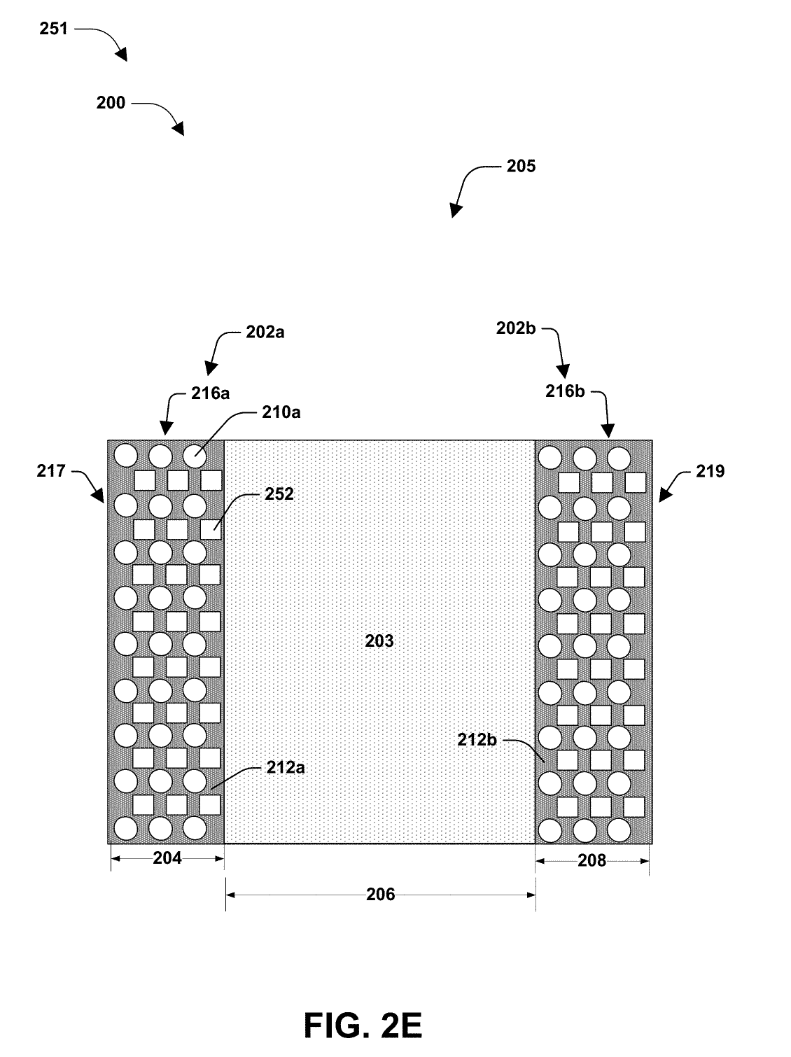

FIGS. 2A-2E illustrate examples of a bearing assembly 200 comprising a hybrid wear resistant coating 205 over a surface of a bearing component (not illustrated). The hybrid wear resistant coating 205 may comprise a first high wear resistant coating 202a, a second high wear resistant coating 202b, and a low wear resistant coating 203. The first high wear resistant coating 202a and the second high wear resistant coating 202b may be over a first high wear area 204 and a second high wear area 208 of the surface, respectively. The low wear resistant coating 203 may be over a low wear area 206 of the surface (e.g., the area of the surface between the first high wear resistant coating 202a and the second high wear resistant coating 202b). The first high wear resistant coating 202a may comprise a first wear resistant matrix 212a and the second high wear resistant coating 202b comprise a second wear resistant matrix 212b. The first wear resistant matrix 212a and the second wear resistant matrix 212b may have a wear resistant matrix composition (e.g., the metal alloys, binders, additives, etc. contained within the wear resistant matrixes 212a-212b). The wear resistant matrix composition may be the same for both the first wear resistant matrix 212a and the second wear resistant matrix 212b. A first set of wear resistant elements 216a and a second set of wear resistant elements 216b may be in the first wear resistant matrix 212a and the second wear resistant matrix 212b, respectively. The wear resistant elements within the sets of wear resistant elements 216a-216b may comprise tungsten carbide.

FIG. 2A illustrates an example of the hybrid wear resistant coating 205 on the bearing component, wherein the first high wear resistant coating 202a is located proximate a first end 217 of the surface of the metal bearing component and the second high wear resistant coating is located proximate a second end 219 of the surface of the metal bearing component. The wear resistant elements within the sets of high wear elements 216a-216b may be circular tiles, such as circular tiles 210a-210d. The circular tiles within the sets of wear resistant elements 216a-216b may be arranged in staggered formation, such as illustrated by circular tiles 210a -210b and circular tiles 210c-210d. In an example, the first wear resistant matrix 212a, the second wear resistant matrix 212b, and the low wear resistant coating 203 may each comprise a compound, element, and/or a binder capable of forming a metallurgic bond at boundaries 218a-218b. For example, the first wear resistant matrix 212a, the second wear resistant matrix 212b, and the low wear resistant coating 203 may each comprise a metal alloy capable of forming the metallurgical bond 218a-218b when the metal alloy is heated beyond a particular temperature (e.g., a flow temperature and/or melting point).

FIG. 2B illustrates an example 221 of the hybrid wear resistant coating 205 on the bearing component, wherein the wear resistant elements within the first set of wear resistant elements 216a are bars 222a-222k and the wear resistant elements within the second set of wear resistant elements 216b are bars 222l-222v. In an example, the bars 222a-222k may extend across the first high wear area 204, such as from the first end 217 to boundary 218a. Likewise, the bars 222l-222v may extend across the second high wear area 204, such as from the second end 219 to boundary 218b. In an example the bars 222a-222v may extend across less that the entire width of the first high wear area 204 and/or the second high wear area 208 (e.g., the bars may extend three-fourths of the way across the width of the high wear areas and be arranged in a staggered pattern, etc.). In an example, spacing bars 222a-222v apart from each other may increase bonding strength and/or provide a more level surface when applied to the bearing component, such as when the surface of the bearing component is a cylindrical surface.

FIG. 2C illustrates an example 231 of the hybrid wear resistant coating 205 on the bearing component, wherein a second low wear resistant coating 236 is over a second low wear area 232 and a third low wear resistant coating 238 is over a third low wear area 234. The second low wear area 232 and the third low wear area 234 may be located proximate the first end 217 and the second end 219. In example 231, the wear resistant elements within the sets of wear resistant elements 216a-216b are hexagonal tiles, such as hexagonal tiles 239a-239b. The hexagonal tiles 239a-239b may form a stronger bond with the wear resistant matrixes 212a-212b as a result of a great surface area for bonding. In an example, the hexagonal tiles 239a-239b may improve the wear resistance of the hybrid wear resistant coating 205 by more evenly distributing forces applied thereto. In this way, the performance of the bearing assembly 200 may be improved. In an example, the second low wear resistant coating 236 and/or the third low wear resistant coating 238 may provide protection for the high wear resistant coatings 202a-202b, such as from chipping and/or pealing that may occur on the first end 217 and/or the second end 219.

FIG. 2D illustrates an example 241 of the hybrid wear resistant coating 205 on the bearing component, wherein the bearing component comprises a fourth low wear area 248, a fifth low wear area 249, and a third high wear area 242. A third high wear resistant coating 202c may be over a third high wear area 242 of the bearing component. The third high wear resistant coating 202c may comprise a third set of wear resistant elements 216c in a third wear matrix 212c. The third high wear resistant coating 202c may be positioned between the first high wear resistant coating 202a and the second high wear resistant coating 202b. A fourth low wear resistant coating 244 may be over a forth low wear area 248 and a fifth low wear resistant coating 246 may be over the fifth low wear area 249. The fourth low wear resistant coating 244 may be located between the first boundary 218a of the first high wear resistant coating 202a and a third boundary 218c of the third high wear resistant coating 202c. The fifth low wear resistant coating 246 may be located between the second boundary 218b of the second high wear resistant coating 202b and a fourth boundary 218d of the third high wear resistant coating 202c. In an example, the third high wear resistant coating 202c may reduce an overall amount of wear on the bearing assembly 200 and/or increase the performance of the bearing assembly 200 (e.g., the third high wear resistant coating 202c may enable the bearing assembly to operate for a longer period of time and/or at a higher rotational speed, such as by further reducing the wear on the other high wear resistant coating and/or the low wear resistant coatings).

FIG. 2E illustrates an example 251 of the hybrid wear resistant coating 205 on the bearing component, wherein at least one of the first high wear resistant coating 202a and/or the second high wear resistant coating 202b comprise wear resistant elements of various shapes. For example, the sets of wear resistant elements 216a-216b may comprise circular tiles such as circular tile 210a and square tiles, such as square tile 252. Utilizing wear resistant elements of various shapes within high wear resistant coatings may improve the overall performance of the hybrid wear resistant coating, such as by modifying how physical stresses are distributed when applied to the bearing component (e.g., utilizing various wear resistant elements may improve the distribution of stress applied to bearing components during slant drilling). In this way, the high wear resistant coatings 202a-202b may be tailored to a particular application and/or wear resistance need for the bearing assembly 200.

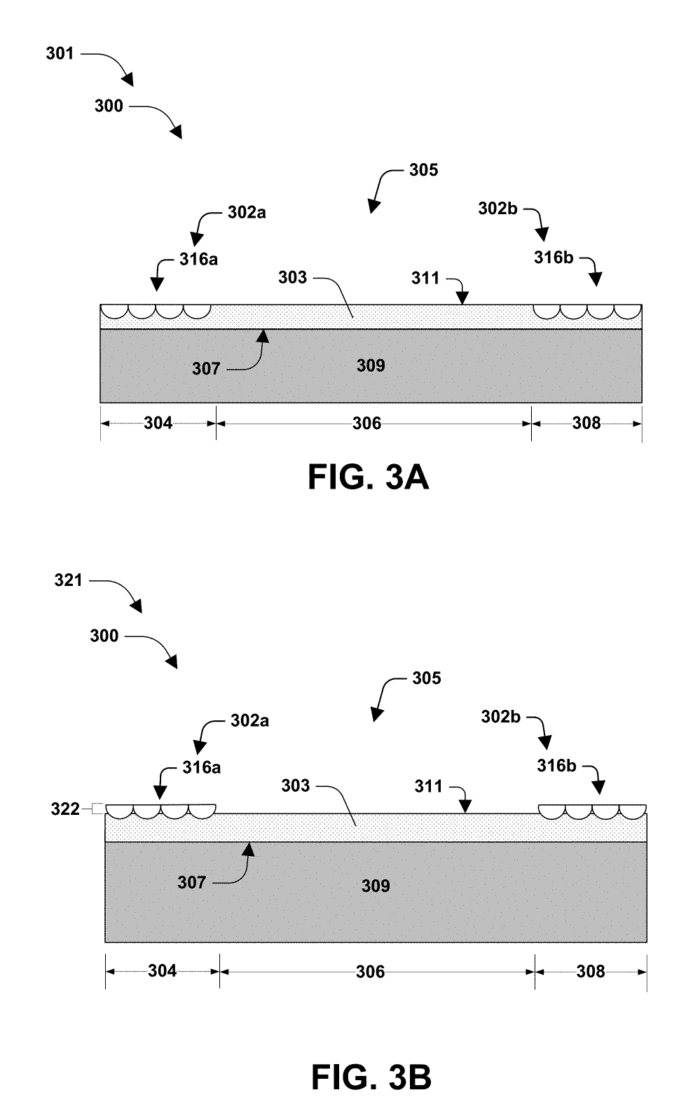

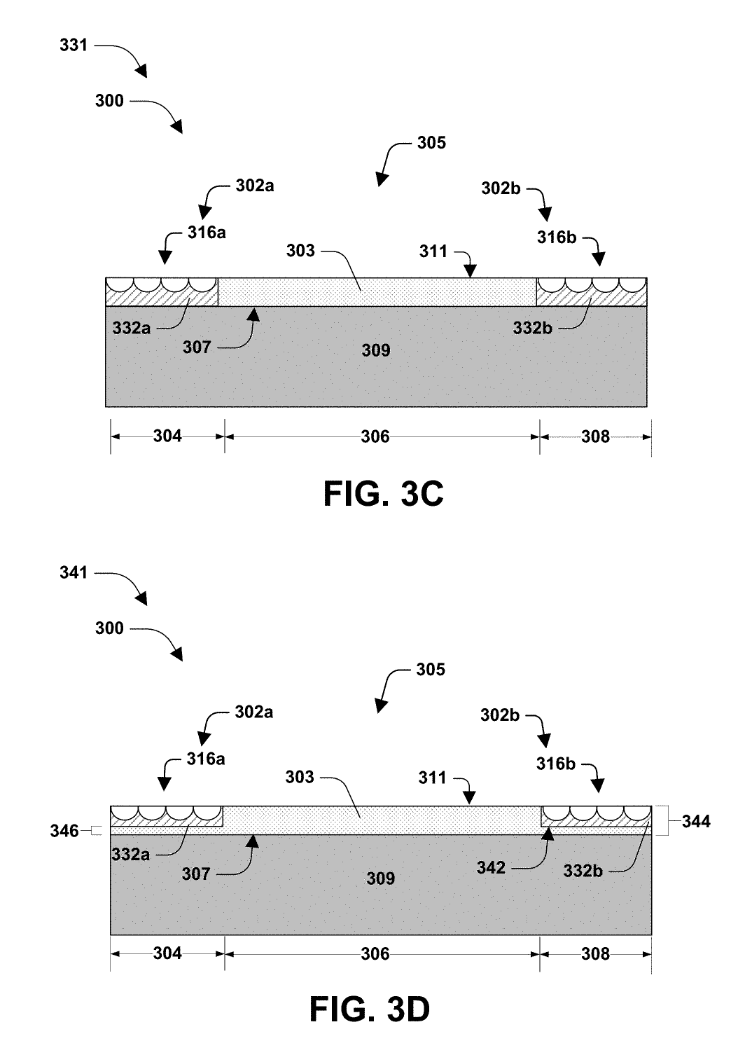

FIGS. 3A-3D illustrate cross sectional views of examples of a bearing assembly 300 comprising a hybrid wear resistant coating 305. The hybrid wear resistant coating 305 may be provided over a surface 307 of a bearing component 309 within the bearing assembly 300. The hybrid wear resistant coating 305 may comprise a first high wear resistant coating 302a, a second high wear resistant coating 302b, and a low wear resistant coating 303. The first high wear resistant coating 302a may comprise a first set of wear resistant elements 316a and the second high wear resistant coating 302b may comprise a second set of wear resistant elements 316b.

FIG. 3A illustrates an example 301 of the bearing assembly 300, wherein the low wear resistant coating 303 is on the surface 307 of the bearing component 309. In this embodiment, the low wear resistant coating 303 may be utilized as the wear resistant matrix for the high wear resistant coatings 302a-302b. For example, the sets of wear resistant elements 316a-316b may be in the low wear resistant coating 303 over a first high wear area 304 and a second high wear area 308. The sets of wear resistant elements 316a-316b may be positioned within the portions of the low wear resistant coating 303 serving as the wear resistant matrix for the high wear resistant coatings 302a-302b so as to form a hybrid wear resistant coating surface 311 that which is level. In an example, utilizing the low wear resistant coating 303 as the wear resistant matrix for the high wear resistant coatings 302a-302b may improve the strength of the hybrid wear resistant coating 305 and/or reduce the manufacturing time for applying the hybrid wear resistant coating 305 to the bearing component 309 (e.g., by utilizing a single coating for both the low wear resistant coating 303 and/or the wear resistant matrix of the high wear resistant coatings 302a-302b, the strength of the hybrid wear resistant coating 305 may be improved because there would be no need for bonding the low wear resistant coating 303 to the wear resistant matrix at a junction point where the coatings meet; utilizing a single coating for both the low wear resistant coating 303 and/or the wear resistant matrix of the high wear resistant coatings 302a-302b may reduce the number of process steps needed to form the hybrid wear resistant coating 305, such as by eliminating additional thermal processing steps for applying a second coating of a different type that has a differing melting point).

FIG. 3B illustrates an example 321 of the bearing assembly 300, wherein the hybrid wear resistant coating surface 311 is elevated (e.g., raised up) proximate the high wear resistant coatings 302a-302b. For example, the sets of wear resistant elements 316a-316b may be partially contained within the low wear resistant coating 303, such that the hybrid coating surface 311 is elevated over the first high wear area 304 and the second high wear area 308 (e.g., the sets of wear resistant elements 316a-316b may extend outwardly from the wear resistant matrix away from the substrate). In an example, the sets of wear resistant elements 316a-316b may extend above (e.g., proud of) the low wear resistant coating a first height 322. In this way, the high wear resistant coatings 302a-302b may be configured to bear additional wear stress as compared to the low wear resistant coating 303, such as from unusual bearing movements which may occur during a drilling process.

FIG. 3C illustrates an example 331 of the bearing assembly 300, wherein a first wear resistant matrix 332a is on the first high wear area 304 of the surface 307 and a second wear resistant matrix 332b is on the second high wear area 308 of the surface 307. The low wear resistant coating 303 may be on the low wear area 306 of the surface 307. FIG. 3D illustrates an example 341 of the bearing assembly 300, wherein the wear resistant matrix 332a-332b are on a low wear resistant coating surface 342 of the low wear resistant coating 303. For example, the wear resistant matrix 332a-332b may be on the low wear resistant coating surface 342 at areas corresponding to the first high wear area 304 and the second high wear area 308, respectively. Put differently, the low wear resistant coating 303 may have a first thickness 344 over the low wear area 306 and the second thickness 346 over the first high wear area 304 and the second high wear area 308. The wear resistant matrix 332a-332b may be over portions of the low wear resistant coating 303 having the second thickness 346, such that the hybrid wear resistant coating surface 311 is level. In an example, the bonding strength of the hybrid wear resistant coating 305 may my improved by bonding the low wear resistant coating to the bearing component 309 and bonding the high wear resistant coatings 302a-302b to the low wear resistant coating 303. In this way, a composition of the low wear resistant coating may be selected based upon a first ability of the composition to bond to the surface 307 of the bearing component 309 and a second composition of the wear resistant matrix 316a-316b may be selected based upon a second ability of the second composition to bond to the sets of wear resistant elements 316a-316b (e.g., the first compound and/or the second compound may be selected based upon the strength of the metallurgical bond created).

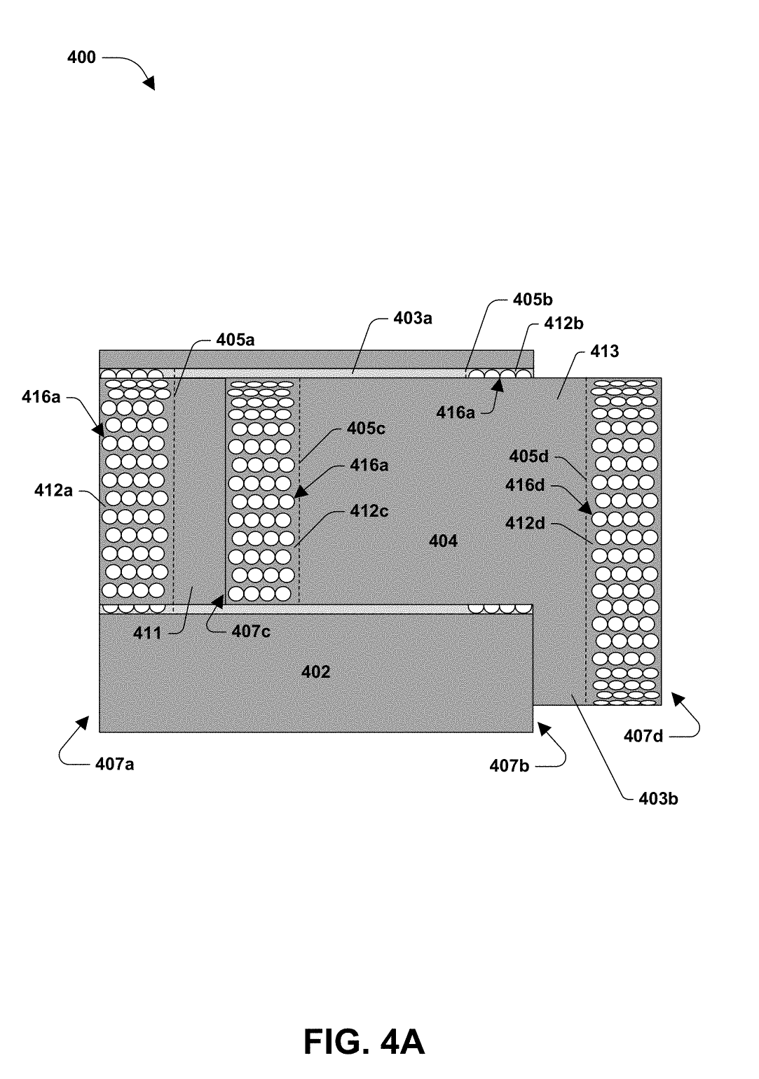

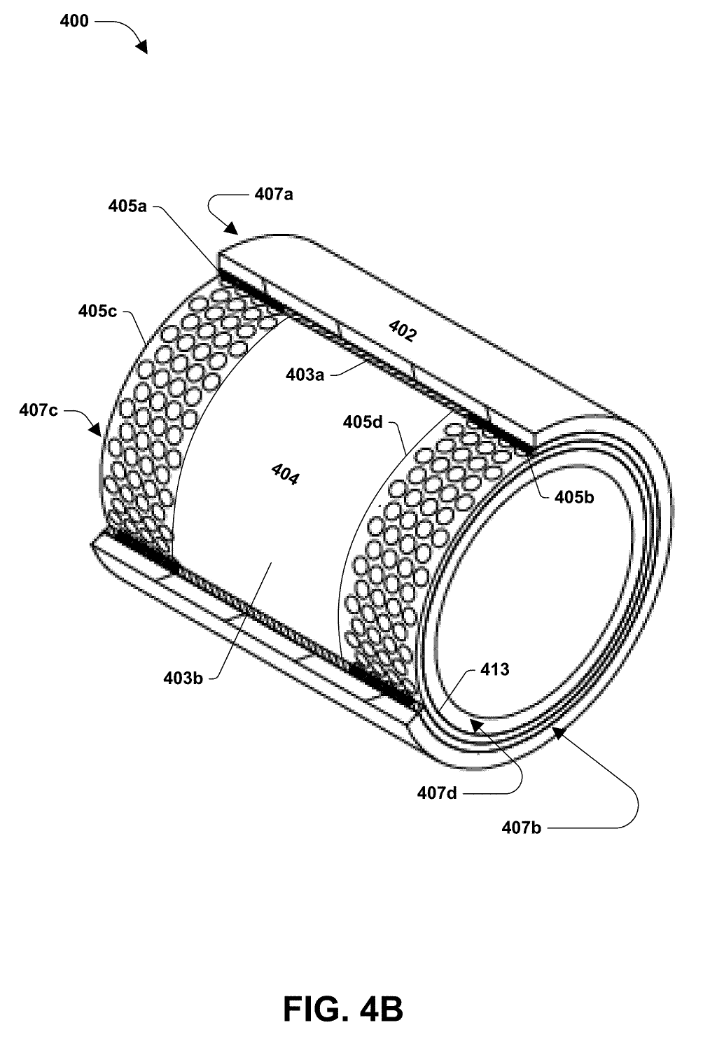

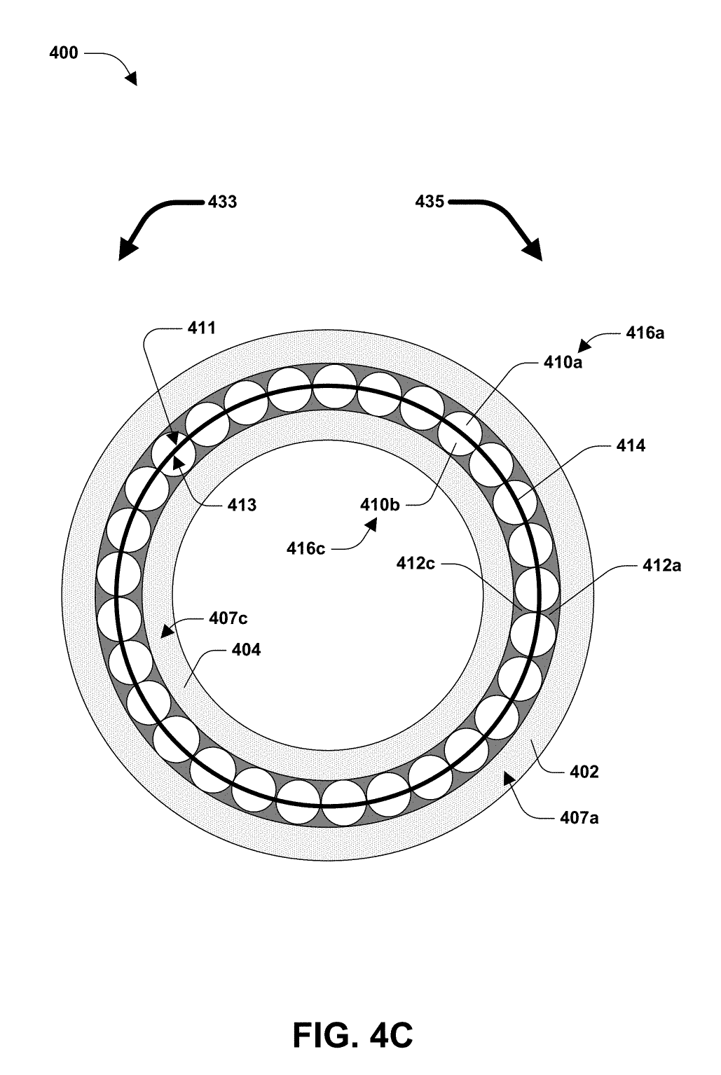

FIGS. 4A-4C illustrate perspective views of a bearing assembly 400. The bearing assembly 400 may comprise an outer radial bearing 402 and an inner radial bearing 404. The outer radial bearing 402 may have a first end 407a, a second end 407b, and an interior surface 411 that defines an interior cavity. The inner radial bearing 404 may be within the interior cavity. The inner radial bearing 404 may comprise a third end 407c, a fourth end 407d, and an exterior surface 413 co-axial to the interior surface 411 of the outer radial bearing 402. Turning to FIG. 4A, an offset cut away view of the bearing assembly 400 is provided. The outer radial bearing 402 may comprise a first hybrid wear resistant coating comprising a first high wear resistant coating 405a, a second high wear resistant coating 405b, and a first low wear resistant coating 403a. The inner radial bearing 404 may comprise a second hybrid coating comprising a third high wear resistant coating 405c, a fourth high wear resistant coating 405d, and a second low wear resistant coating 403b. The first high wear resistant coating 405a may be proximate the first end 407a, the second high wear resistant coating 405b may be proximate the second end 407b, the third high wear resistant coating 405c may be proximate the third end 407c, and the fourth high wear resistant coating 405d may be proximate the fourth end 407d. The high wear resistant coatings 405a-405d may comprise wear resistant matrix 412a-412d and sets of wear resistant elements 416a-416d within the wear resistant matrix 412a-412d.

In an example, responsive to the inner radial bearing 404 being aligned with the outer radial bearing 402, the first high wear resistant coating 405a of the outer radial bearing 402 may be positioned parallel to the third high wear resistant coating 405c of the inner radial bearing 404 and the second high wear resistant coating 405b of the outer radial bearing 402 may be positioned parallel to the fourth high wear resistant coating 405d of the inner radial bearing 404, as illustrated by FIG. 4B. In this way, the high wear resistant coatings 405a-405c of the outer radial bearing may be configured to contact the high wear resistant coatings of the inner radial bearing 404 so as to reduce wear stresses on the low wear resistant coatings 430a-403b.

Turning to FIG. 4C a perspective view of the bearing assembly 400 looking into the first end 407a and third end 407c of the outer radial bearing 402 and the inner radial bearing 404 is provided. A contact boundary (represented by line 414) may be located between the inner surface 411 of the outer radial bearing 402 and the outer surface 413 of the inner radial bearing 404. The first set of wear resistant elements 416a may be positioned parallel to the third set of wear resistant elements 416c. For example, a first wear resistant element 410a of the outer radial bearing 402 may be parallel to a second wear element 410b of the inner radial bearing 404. In an example, the outer radial bearing 402 is stationary and the inner radial bearing 404 is able to rotate in a first direction (represented by arrow 433) and/or a second direction (represented by 435).

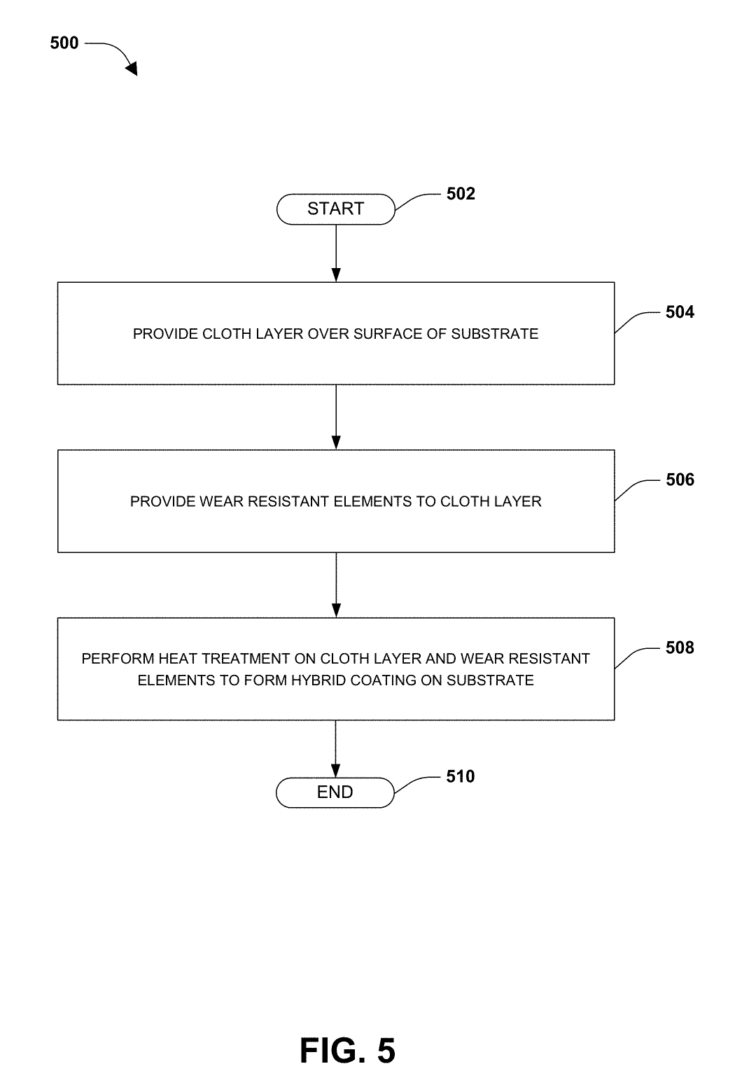

FIG. 5 illustrates an example method of forming a hybrid coating on a substrate, such as radial bearing surface within a bearing assembly. At 502, the method 500 starts. At 504, a first cloth layer is provided over a surface of the substrate. The first cloth layer may comprise a binder, a lubricant, and/or a metal alloy. In an example, the metal alloy may comprise copper, nickel, manganese, silver, tin, cobalt, silicon, cadmium, manganese, zinc, cobalt, tungsten, and/or the like. The binder and/or the lubricant may comprise at least one of an alkyd, a phenol, a vinyl-butyral, an epoxy, a polymide, a polytetrafluoroethylene, a molybdenum bisulphate, a graphite, a phthalocyanine, and/or the like. In an example, the metal alloy may be provided as a powder (e.g., hard particles, nanoparticles, etc.) disbursed in the binder and/or the lubricant. The first cloth layer may be temporarily fixed to the surface of the substrate by an adhesive (e.g., cement, epoxy, and/or the like). The surface may comprise a high wear area and/or a low wear area. The first cloth layer may be applied over the high wear area and/or the low wear area of the surface of the substrate.

In an example, a second cloth layer may be applied over the surface substrate and/or on the first cloth layer. For example, the first cloth layer may be applied over the entire surface and the second cloth layer may be applied over a first portion of the first cloth layer corresponding to the high wear area of the surface but not a second portion of the first cloth layer corresponding to the low wear area of the surface. In an example, the first cloth layer may be applied to the low wear area of the surface of the substrate and the second cloth layer may be applied to the high wear areas of the surface of the substrate. In an example, responsive to second cloth layer being provide, the first cloth layer may comprise a powdered braze metal alloy, such as an austenite nickel-chromium-based superalloy. The first cloth layer and/or the second cloth layer may be selected so as to have a melting point that is lower than that of the substrate, such that the cloth layers may transition from a solid state to a liquid state but the substrate may remain in a solid state. In an example, one or more techniques for forming at least one of the first cloth layer or the second cloth layer are disclosed in U.S. Pat. No. 3,743,556 to Breton et al., the contents of which are hereby incorporated by reference herein.

At 506, wear resistant elements may be provided. In an example, the wear resistant elements may be provide to the first cloth layer and/or the second cloth layer in an area corresponding to the high wear area. The wear resistant elements may be provided by hand and/or by an automated system. The wear resistant elements may comprise wear resistant compounds capable of withstanding high temperature heat treatments, such as tungsten carbide. In an example, the wear resistant compounds should be able to undergo heat treatments with little or no cracking, degrading, and/or other performance sacrifices. For example, the wear resistant compounds may comprise compounds capable of withstanding temperatures between 700 degrees Celsius and 1550 degrees Celsius. In an example, the wear resistant elements may comprise compounds with liquefaction points above at least one of 850 degrees Celsius, 1200 degrees Celsius, 1400 degrees Celsius, and/or 1550 degrees Celsius. In an example, the wear resistant compounds may be selected from compounds capable of withstanding temperatures greater than 1400 degrees Celsius but less than 1550 degrees Celsius. Additives, such as brazing additives, may be added to the cloth layers to reduce the temperature needed for the cloth layers to at least partially liquefy. In this way, the likelihood of the substrate and/or the wear resistant elements being negatively affected by heat treatments may be reduced (e.g., adding a quenching salt to lower the melting point of the cloth layer may reduce the likelihood of the substrate cracking as a result of the heat treatment).

At 508, a heat treatment may be performed on the cloth layers and the wear resistant elements to form the high wear resistant coating and the low wear resistant coating. In an example, the heat treatment may be performed in a furnace (e.g., a gas furnace, an electrical furnace, a microwave, an inferred furnace, etc.). The furnace may be configured to maintaining a controlled atmosphere comprising oxygen, nitrogen, hydrogen, and/or argon. In an example, the furnace may be a vacuum furnace configured to maintain a vacuum environment.

The heat treatment may be performed at a set process temperature for a set process time. The process time and/or the process temperature may be selected based upon the compounds (e.g., metal alloys) of the wear resistant elements and/or the cloth layers (e.g., characteristics of the compounds contained therein, such as wettability, purity, melting point, liquidus point, etc. may be utilized to determine suitable process times and/or process temperatures). In an example, the process temperature may be at least equal to liquidus point (LP) and/or melting point (MP) of the metal alloys of the cloth layer and/or the wear resistant elements. For example, responsive to the wear resistant elements comprising tungsten carbide and the cloth layer comprising nickel, copper, and/or cobalt, the process temperature may be between 900 degrees to 1300 degrees Celsius and the process time may be between 45 minutes to 90 minutes.

In an example, the heat treatment may cause the first cloth layer and/or the second cloth layer to be consolidated to form a hybrid wear resistant coating. For example, the metal alloy of the cloth layers may infiltrate the surface of the substrate and/or the wear resistant elements as a liquid to form a wear resistant matrix binding the wear resistant elements to the substrate (e.g., a metallurgical bond may be formed between the substrate and the wear resistant elements). In an example, one or more components of the cloth layers may evaporate during the heat treatment (e.g., the organic binder, the lubricant, and/or the adhesive).

In an example, the second cloth layer may be applied after a first heat treatment. Responsive to the second cloth layer being applied, a second heat treatment may be performed to form the hybrid wear resistant coating. The second heat treatment may be performed at a different process temperature and/or for a different process time than the first heat treatment (e.g., the first heat treatment may be performed on the first cloth layer based upon the characteristics of the compounds of the first cloth layer and the second heat treatment may be performed on the second cloth layer based upon the characteristics of the compounds of the second cloth layer). For example, responsive to the first cloth layer having a higher melting point temperature than the second cloth layer, the second cloth layer may be applied after the first heat treatment is completed and the second heat treatment may be performed at a lower process temperature. In this way, the first cloth layer may not be liquefied for a second time by the second heat treatment and/or the second cloth layer may not be exposed to unnecessarily high process temperatures that could result in damage to the hybrid wear resistant coating (e.g., reduced likelihood of damage, delamination, cracking, etc.).

In example, responsive to the first cloth layer being applied to the surface of the substrate and the first heat treatment being performed to form the low wear resistant coating over the surface of the substrate, the second cloth layer may be applied over the low wear resistant coating in areas know to correspond to high wear areas and the wear resistant elements may be positioned within the second cloth layer. The second heat treatment may be performed to form the high wear resistant coating of the hybrid wear resistant coating over the low wear resistant coating. In an example, responsive to the first cloth layer being applied to the surface of the substrate corresponding to high wear areas, the wear resistant elements being positioned within the first cloth layer, and the first heat treatment being performed to form the high wear resistant coating over the high wear areas, the second cloth layer may be applied to the still exposed areas on the surface of the substrate (e.g., the second cloth layer may be applied next to and/or in between the high wear resistant coating). The second heat treatment may be performed to form the low wear resistant coating of the hybrid wear resistant coating on the surface of the substrate.

Subsequent to the completion of the heat treatments, the hybrid wear resistant coating may be cooled to below the solidification temperature (e.g., the hybrid wear resistant coating may be allowed to harden and/or come to room temperature). The hybrid coating may be machined to a desired design and/or specifications (e.g., height, smoothness, shape, etc.). For example, the high wear resistant coating and the low wear resistant coating of the hybrid wear resistant coating may be machined to form a flush surface and/or level surface. In an example, a first high wear resistant coating in a first high wear area and a second high wear resistant coating in a second high wear area may be machined to be level with each other but extend above the low wear resistant coating of the hybrid wear resistant coating. The hybrid wear resistant coating may be machined by a direct contact machining process (e.g., cutting, polishing, and/or grinding with a direct contact tool, such as a diamond cutting tool, silicon-carbide grinding wheels, etc.) and/or a non-direct contact machining process (e.g., cutting, polishing, and/or leveling with a non-contact tool, such as a narrow beam laser, a water jet cutting tool, etc.). In an example, utilizing the non-direct contact machining process may yield high quality results with little to no damage, delamination, and/or cracking. At 510, the method ends.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A bearing assembly comprising:
a substrate having a surface; and
a hybrid wear resistant coating over the surface of the substrate, the hybrid wear resistant coating comprising one or more of:
a high wear resistant coating over a high wear area of the surface, the high wear resistant coating comprising:
a wear resistant matrix over the high wear area of the surface; and
a set of wear resistant elements within the wear resistant matrix; or
a low wear resistant coating over a low wear area of the surface.

2. The bearing assembly of claim 1, wherein the bearing assembly is a downhole mud lubricated bearing assembly.

3. The bearing assembly of claim 1, wherein the surface is an interior cylindrical wear surface of a radial bearing or an exterior cylindrical wear surface of the radial bearing.

4. The bearing assembly of claim 1, the hybrid wear resistant coating comprising:
a second high wear resistant coating over a second high wear area of the surface, the second high wear resistant coating comprising:
a second wear resistant matrix over the second high wear area of surface; and
a second set of wear resistant elements within the second wear resistant matrix.

5. The bearing assembly of claim 4, the surface of the substrate having a first end and a second end, and the high wear resistant coating proximate the first end and the second high wear resistant coating proximate the second end.

6. The bearing assembly of claim 1, comprising:
a second substrate having a second surface, the second surface being parallel to the surface; and
a second hybrid wear resistant coating over the second surface of the second substrate, the second hybrid wear resistant coating comprising:
a second high wear resistant coating over a second high wear area of the second surface, the second high wear resistant coating comprising:
a second wear resistant matrix over the second high wear area of the second surface; and
a second set of wear resistant elements within the second wear resistant matrix; and
a second low wear resistant coating over a second low wear area of the second surface.

7. The bearing assembly of claim 6, wherein the high wear resistant coating over the substrate is configured to contact the second high wear resistant coating over the second substrate.

8. The bearing assembly of claim 1, wherein the hybrid wear resistant coating has a uniform thickness.

9. The bearing assembly of claim 1, wherein the hybrid wear resistant coating has a first thickness over the high wear area and a second thickness over the low wear area.

10. The bearing assembly of claim 9, wherein a wear resistant element of the set of wear resistant elements extends outwardly from the wear resistant matrix away from the substrate.

11. The bearing assembly of claim 1, wherein the low wear resistant coating contacts the surface of the substrate over the low wear area and the high wear area, and the high wear resistant coating contacts the low wear resistant coating over the high wear area.

12. The bearing assembly of claim 1, wherein a wear resistant element of the set of wear resistant elements comprises at least one of:
a metal carbide, a metal boride, or a diamond crystalline compound.

13. The bearing assembly of claim 12, wherein the metal carbide is tungsten carbide.

14. The bearing assembly of claim 1, the low wear resistant coating comprising:
metal particles.

15. The bearing assembly of claim 1, wherein a wear resistant element of the set of wear resistant elements has at least one of a polygonal or circular cross-sectional shape.

16. The bearing assembly of claim 1, wherein the wear resistant matrix is metallurgically bonded to the substrate.

17. The bearing assembly of claim 1, the low wear resistant coating comprising at least one of a weld overlay alloy or a carbide particle within a binder.

18. A bearing assembly comprising:
a metal substrate having a surface; and
a hybrid wear resistant coating over the surface of the metal substrate, the hybrid wear resistant coating comprising:
a first high wear resistant coating over a first high wear area of the surface, the first high wear resistant coating comprising:
a first wear resistant matrix over the first high wear area of the surface; and
a first set of wear resistant elements within the first wear resistant matrix;
a second high wear resistant coating over a second high wear area of the surface, the second high wear resistant coating comprising:
a second wear resistant matrix over the second high wear area of the surface; and
a second set of wear resistant elements within the second wear resistant matrix; and
a low wear resistant coating over a low wear area of the surface and between the first high wear resistant coating and the second high wear resistant coating.

19. A bearing assembly comprising:
an outer radial bearing having a first end, a second end, and an interior surface that defines an interior cavity;
a first hybrid wear resistant coating over the interior surface of the outer radial bearing, the first hybrid wear resistant coating comprising:
a first high wear resistant coating over the interior surface proximate the first end, the first high wear resistant coating comprising:
a first wear resistant matrix over the interior surface proximate the first end; and
a first set of wear resistant elements within the first wear resistant matrix;
a second high wear resistant coating over the interior surface proximate the second end, the second high wear resistant coating comprising:
a second wear resistant matrix over the interior surface proximate the second end; and
a second set of wear resistant elements within the second wear resistant matrix; and
a first low wear resistant coating over the interior surface between the first high wear resistant coating and the second high wear resistant coating.

20. The bearing assembly of claim 19, comprising:
an inner radial bearing within the interior cavity having a third end, a fourth end, and an exterior surface parallel to the interior surface of the outer radial bearing;
a second hybrid wear resistant coating over the exterior surface of the inner radial bearing, the second hybrid wear resistant coating comprising:
a third high wear resistant coating over the exterior surface proximate the third end, the third high wear resistant coating comprising:
a third wear resistant matrix over the exterior surface proximate the third end; and
a third set of wear resistant elements within the third wear resistant matrix;
a fourth high wear resistant coating over the exterior surface proximate the fourth end, the fourth high wear resistant coating comprising:
a fourth wear resistant matrix over the exterior surface proximate the fourth end; and
a fourth set of wear resistant elements within the fourth wear resistant matrix; and
a second low wear resistant coating over the exterior surface between the third high wear resistant coating and the fourth high wear resistant coating.

21. The bearing assembly of claim 19, wherein the inner radial bearing and the outer radial bearing are rotational relative to one another.
